(19) United States
(12) Patent Application Publication
(10) Pub. No.: US 2020/0274906 A1
(43) Pub. Date: Aug. 27, 2020

(54) METHODS AND SYSTEMS FOR REAL-TIME MEDIA CONTENT SHARING

(71) Applicant: Hoc Drop, LLC, Norwalk, CT (US)

(72) Inventor: Christopher BAYLIS, Norwalk, CT (US)

(21) Appl. No.: 16/800,314

(22) Filed: Feb. 25, 2020

Related U.S. Application Data
(60) Provisional application No. 62/811,190, filed on Feb. 27, 2019.

(51) Int. Cl. H04L 29/06; H04L 29/08

(52) U.S. Cl. CPC H04L 65/1069; H04L 67/18; H04L 67/06; H04L 65/601

(57) ABSTRACT

The present disclosure provides methods for sharing media in real time. The methods may comprise initiating an ad hoc connection between a sending peer device and one or more receiving peer devices; using the sending peer device to select a media to share with a plurality of receiving peer devices comprising the one or more receiving peer devices; using the ad hoc connection to send a file corresponding to the selected media to the one or more receiving peer devices, which file may be stored temporarily on the one or more receiving peer devices such that the media is capable of being displayed and manipulated on a receiving peer device of the plurality of receiving peer devices without manipulating the media displayed on the sending peer device and another receiving peer device of the plurality of receiving peer devices; and terminating the ad hoc connection.

### CROSS-REFERENCE

This application claims priority to U.S. Provisional Patent Application No. 62/811,190 filed on Feb. 27, 2019, which application is entirely incorporated herein by reference for all purposes.

### BACKGROUND

Mobile devices such as smartphones and tablets may enable users to capture, edit, and share photos anytime and anywhere. With mobile devices becoming more ubiquitous, photo sharing on mobile devices has also become increasingly popular among mobile device users. Photo sharing platforms currently available may allow users to publicly upload their photos to the Internet for other mobile device users to view. Mobile device users can also privately share photos by sending the photos directly to the mobile devices of other users via an Internet connection or a cellular data network. Alternatively, if no Internet connection or cellular data network is available, users can display the photos on their mobile device and physically share their mobile device with other individuals in the vicinity.

### SUMMARY

Recognized herein are various limitations with systems and methods currently available for sharing media content (e.g., photos or videos). For example, in offline contexts where an Internet connection or cellular data network may not be available, readily accessible, or convenient for sharing media content, the sharing of such media content may involve physically sharing one device among many viewers, or having many viewers group around one device to view the same media content. Further, when sharing photos offline with multiple viewers, the multiple viewers may have limited ability to individually control or manipulate the image displayed on a single device without disrupting the viewing experience of other viewers. With the increasing prevalence of mobile device photo sharing, recognized herein is a need for photo sharing platforms that may allow multiple viewers to share photos and individually manipulate shared photos without using an Internet connection or a cellular data network.

Provided herein are methods and systems for sharing media content (e.g., photos) in real time or substantially real time using an ad hoc connection.

In an aspect, the present disclosure provides a method for sharing media in real time. The method may comprise initiating an ad hoc connection between a sending peer device and one or more receiving peer devices. In some embodiments, the method may further comprise using the sending peer device to select a media to share with the one or more receiving peer devices connected to the sending peer device through the ad hoc connection. In some embodiments, a file corresponding to the media may be stored locally on the sending peer device such that the media is capable of being displayed and manipulated on the sending peer device. In some embodiments, the method may further comprise using the ad hoc connection to send the file from the sending peer device to the one or more receiving peer devices. In some embodiments, the media may be displayed on the sending peer device and each of the one or more receiving peer devices after the file is sent from the sending peer device and received at the one or more receiving peer devices. In some embodiments, the file may be temporarily stored on the one or more receiving peer devices such that the media is capable of being displayed and manipulated on each of the one or more receiving peer devices without manipulating the media displayed on the sending peer device. In some embodiments, the method may further comprise terminating the ad hoc connection. Upon termination of the ad hoc connection, the file may not accessible by the one or more receiving peer devices.

In some embodiments, the method may further comprise using the sending peer device to manipulate the media displayed on the sending peer device. The manipulation of the media displayed on the sending peer device may manipulate the media displayed on each of the one or more receiving peer devices.

In some embodiments, the one or more receiving peer devices may comprise a plurality of receiving peer devices. In some embodiments, a first receiving peer device of the plurality of receiving peer devices may be configured to manipulate the media displayed on the first receiving peer device without manipulating the media displayed on a second receiving peer device of the plurality of receiving peer devices.

In some embodiments, at least one receiving peer device of the plurality of receiving peer devices may be configured to share one or more files via the ad hoc connection. In some embodiments, the sending peer device may operate as an additional receiving peer device and the at least one receiving peer device may operate as an additional sending peer device when the one or more files are shared via the ad hoc connection.

In some embodiments, the additional sending peer device may be configured to (i) send an additional file corresponding to an additional media to the additional receiving peer device and another receiving peer device of the plurality of receiving peer devices, (ii) display the additional media on the additional sending peer device, and (iii) manipulate the additional media displayed on the additional sending peer device. In some embodiments, the manipulation of the additional media displayed on the additional sending peer device may manipulate the additional media displayed on the additional receiving peer device and the another receiving peer device.

In some embodiments, the additional receiving peer device may be configured to (i) receive an additional file corresponding to an additional media selected at the additional sending peer device for sharing with the additional receiving peer device and another receiving peer device of the plurality of receiving peer devices, (ii) display the additional media on the additional receiving peer device, and (iii) manipulate the additional media displayed on the additional receiving peer device without manipulating or modifying the additional media displayed on the additional sending peer device and the another receiving peer device.

In some embodiments, the sending peer device may be configured to connect to the one or more receiving peer devices using a quick response (QR) code generated on the sending peer device. In some embodiments, the sending peer device may be configured to reconnect to at least one receiving peer device of the one or more receiving peer devices after termination of the ad hoc connection between the sending peer device and the at least one receiving peer device, without using the QR code.

In some embodiments, the sending peer device may be configured to connect to the one or more receiving peer devices using a quick response (QR) code generated on the one or more receiving peer devices. In some embodiments, the sending peer device may be configured to reconnect to at least one receiving peer device of the one or more receiving peer devices after termination of the ad hoc connection between the sending peer device and the at least one receiving peer device, without using the QR code.

In another aspect, the present disclosure provides a method for sharing media in real time. The method may comprise initiating an ad hoc connection between a receiving peer device and a sending peer device. In some embodiments, the method may further comprise receiving, at the receiving peer device, a file corresponding to a media selected at the sending peer device for sharing with the receiving peer device connected to the sending peer device through the ad hoc connection. The media may be displayed on the sending peer device and the receiving peer device after the file is sent from the sending peer device and received at the receiving peer device. In some embodiments, the file corresponding to the media may be stored temporarily on the receiving peer device.

In some embodiments, the method may further comprise using the receiving peer device to display and manipulate the media displayed on the receiving peer device without manipulating the media displayed on the sending peer device. In some embodiments, the method may further comprise terminating the ad hoc connection. Upon termination of the ad hoc connection, the media may not be accessible by the receiving peer device.

In some embodiments, a manipulation of the media displayed on the sending peer device may manipulate the media displayed on the receiving peer device.

In some embodiments, the file corresponding to the media may be received at a plurality of receiving peer devices comprising the receiving peer device. In some embodiments, the method may further comprise using the receiving peer device to display and manipulate the media displayed on the receiving peer device without manipulating or modifying the media displayed on another receiving peer device of the plurality of receiving peer devices.

In some embodiments, the sending peer device may operate as an additional receiving peer device and the receiving peer device may operate as an additional sending peer device when the receiving peer device is used to share one or more files via the ad hoc connection.

In some embodiments, the additional receiving peer device may be configured to (i) receive an additional file corresponding to an additional media selected at the additional sending peer device for sharing with the additional receiving peer device and the another receiving peer device, (ii) display the additional media on the additional receiving peer device, and (iii) manipulate the additional media displayed on the additional receiving peer device without manipulating or modifying the additional media displayed on the additional sending peer device and the another receiving peer device.

In some embodiments, the additional sending peer device may be configured to (i) send an additional file corresponding to an additional media to the additional receiving peer device and the another receiving peer device, (ii) display the additional media on the additional sending peer device, and (iii) manipulate the additional media displayed on the additional sending peer device. In some embodiments, the manipulation of the additional media displayed on the additional sending peer device may manipulate the additional media displayed on the additional receiving peer device and the another receiving peer device.

In some embodiments, the receiving peer device may be configured to connect to the sending peer device using a quick response (QR) code generated on the sending peer device. In some embodiments, the receiving peer device may be configured to reconnect to the sending peer device alter the ad hoc connection is terminated between the receiving peer device and the sending peer device, without using the QR code.

In some embodiments, the receiving peer device may be configured to connect to the sending peer device using a quick response (QR) code generated on the receiving peer device. In some embodiments, the receiving peer device may be configured to reconnect to the sending peer device after the ad hoc connection between the receiving peer device and the sending peer device is terminated, without using the QR code.

In another aspect, the present disclosure provides a system for sharing media in real time. The system may comprise one or more computer processors and computer memory coupled thereto. The computer memory may comprise machine executable code that, upon execution by the one or more computer processors, may implement a method for sharing media in real time. The method may comprise: (a) initiating an ad hoc connection between a sending peer device and one or more receiving peer devices; (b) using the sending peer device to select a media to share with the one or more receiving peer devices connected to the sending peer device through the ad hoc connection, wherein a file corresponding to the media may be stored locally on the sending peer device such that the media is capable of being displayed and manipulated on the sending peer device; (c) using the ad hoc connection to send the file from the sending peer device to the one or more receiving peer devices, wherein the media may be displayed on the sending peer device and each of the one or more receiving peer devices after the file is sent from the sending peer device and received at the one or more receiving peer devices, and wherein the file may be temporarily stored on the one or more receiving peer devices such that the media is capable of being displayed and manipulated on each of the one or more receiving peer devices without manipulating the media displayed on the sending peer device; and (d) subsequent to (c), terminating the ad hoc connection, wherein upon termination of the ad hoc connection, the file may not be accessible by the one or more receiving peer devices.

In another aspect, the present disclosure provides a system for sharing media in real time. The system may comprise one or more computer processors and computer memory coupled thereto, wherein the computer memory may comprise machine executable code that, upon execution by the one or more computer processors, may implement a method for sharing media in real time. The method may comprise (a) initiating an ad hoc connection between a receiving peer device and a sending peer device; (b) receiving, at the receiving peer device, a file corresponding to a media selected at the sending peer device for sharing with the receiving peer device connected to the sending peer device through the ad hoc connection, wherein the media may be displayed on the sending peer device and the receiving peer device after the file is sent from the sending peer device and received at the receiving peer device, and wherein the file corresponding to the media may be stored temporarily on the receiving peer device; (c) using the receiving peer device to display and manipulate the media displayed on the receiving peer device without manipulating the media displayed on the sending peer device; and (d) subsequent to (c), terminating the ad hoc connection, wherein upon termination of the ad hoc connection, the media nay not be accessible by the receiving peer device.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A schematically illustrates an ad hoc media sharing session initiated between a sending peer device and one or more receiving peer devices, in accordance with some embodiments.

FIG. 1B schematically illustrates a sending peer device that manipulates a media displayed on one or more receiving peer devices by manipulating the media displayed on the sending peer device, in accordance with some embodiments.

FIG. 1C schematically illustrates a receiving peer device that manipulates a media displayed on the receiving peer device without manipulating the media displayed on the sending peer device or another receiving peer device, in accordance with some embodiments.

FIG. 2A schematically illustrates a receiving peer device that operates as an additional sending peer device and a sending peer device that operates as an additional receiving peer device, in accordance with some embodiments.

FIG. 2B schematically illustrates an additional sending peer device that manipulates an additional media displayed on an additional receiving peer device and one or more receiving peer devices by manipulating the additional media displayed on the additional sending peer device, in accordance with some embodiments.

FIG. 2C schematically illustrates an additional receiving peer device that manipulates an additional media displayed on the additional receiving peer device without manipulating the additional media displayed on an additional sending peer device and one or more receiving peer devices, in accordance with some embodiments.

FIG. 3 schematically illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

As used herein, the terms “real-time” or “real time” generally refer to a simultaneous or substantially simultaneous occurrence of a first event or action (e.g., a sharing of media content by a first peer device) with respect to an occurrence of a second event or action (e.g., a display of the media content on a second peer device). In some cases, the term “real time” may generally refer to a simultaneous or substantially simultaneous occurrence of a first event or action (e.g., a first manipulation of media content displayed on a first peer device) with respect to an occurrence of a second event or action (e.g., a second manipulation of media content displayed on a second peer device, wherein the second manipulation of the media content is substantially similar or identical to the first manipulation of the media content on the first peer device). A real time action or event may be performed within a response time of less than one or more of the following: ten seconds, five seconds, one second, a tenth of a second, a hundredth of a second, a millisecond, or less relative to at least another event or action. A real time action may be performed by one or more computer processors.

In an aspect, the present disclosure provides a method for sharing media content in real time. The method may comprise initiating an ad hoc connection between a sending peer device and one or more receiving peer devices. Next, the sending peer device may be used by a user to select a media to share with the one or more receiving peer devices. The one or more receiving peer devices may be connected to the sending peer device through the ad hoc connection. A file corresponding to the media may be stored locally on the sending peer device such that the media is capable of being displayed and manipulated on the sending peer device. Next, the ad hoc connection may be used to send the file corresponding to the media from the sending peer device to the one or more receiving peer devices. The media may be displayed on the sending peer device and each of the one or more receiving peer devices after the file is sent from the sending peer device to the one or more receiving peer devices. The file may be temporarily stored on the one or more receiving peer devices such that the media associated with the file may be capable of being displayed and manipulated on each of the one or more receiving peer devices without manipulating the media displayed on the sending peer device. Next, the ad hoc connection may be terminated. Upon termination of the ad hoc connection, the file corresponding to the media may not be accessible by said one or more receiving peer devices.

The methods disclosed herein may be used to share media content in real time. In an example, a sending peer device (e.g., a first iPhone) may use an ad hoc connection to connect to a first receiving peer device (e.g., a second iPhone) and a second receiving peer device (e.g., a third iPhone). The sending peer device may send a media to the first receiving peer device and the second receiving peer device. The media may be displayed on the sending peer device, the first receiving peer device and the second receiving peer device. The sending peer device may manipulate the media (e.g., by zooming into a first portion of the media). The manipulation of the media on the sending peer device may be replicated on the first receiving peer device and the second receiving peer device such that the media displayed on the first receiving peer device and the second receiving peer device may also be zoomed into the first portion of the media. The first receiving peer device may manipulate the media by zooming into a second portion of the media. The second receiving peer device may manipulate the media by zooming into a third portion of the media. The first receiving peer device may zoom into the second portion of the media without manipulating or modifying the media displayed on the sending peer device or the second receiving peer device. The second receiving peer device may zoom into the third portion of the media without manipulating or modifying the media displayed on the sending peer device or the first receiving peer device. The methods disclosed herein may allow one or more receiving peer devices to individually manipulate a media without manipulating the media displayed on a sending peer device or another receiving peer device. The methods disclosed herein may allow a sending peer device to manipulate a media displayed on one or more receiving peer devices by manipulating the media displayed on the sending peer device. For example, when the sending peer device manipulates the media displayed on the sending peer device, the same media displayed on one or more receiving peer devices may be manipulated in a manner substantially similar to the manner in which the media on the sending peer device is manipulated.

The methods disclosed herein may be implemented using an ad hoc connection. An ad hoc connection may be a temporary connection between one or more peer devices. Such temporary connection may be usable until terminated by a user. An ad hoc connection may be established between one or more peer devices without using an existing wired or wireless Internet connection, an external cellular data network, or pre-existing network infrastructure (e.g., routers, modems, and/or wireless access points). An ad hoc connection may be a peer-to-peer (i.e., a device-to-device) connection established directly between two or more peer devices using connectivity hardware built into and/or internal to the two or more peer devices. The connectivity hardware within the two or more peer devices may include Bluetooth chipsets, WiFi chipsets, radio transmitters, radio receivers, antennas, and/or any other hardware configured to allow a peer device to process, send, or receive data. In some cases, the ad hoc connection may be implemented in part using Apple™ Multipeer Connectivity framework.

In some cases, the ad hoc connection may be implemented in part using the Internet, an internet and/or extranet, or an intranet and/or extranet that is in communication with the Internet. Alternatively, the ad hoc connection may be implemented in part using a telecommunications and/or data network. In other cases, the ad hoc connection may be implemented in part using one or more computer servers, which can enable distributed computing, such as cloud computing.

The ad hoc connection may be used to connect one or more peer devices to each other. A peer device may be a mobile device (e.g., smartphone), handheld device, desktop computer, laptop computer, netbook, electronic tablet or similar device, networking device, personal digital assistant, wearable device, head mounted computer or display, or any other device, component, module, subsystem or system capable of processing electronic data, or any combination thereof. The peer device may be a smartphone with a mobile application installed, and the mobile application may be configured to initiate and/or manage an ad hoc between one or more peer devices to allow sharing of media content between the one or more peer devices. The peer device may be a receiving peer device, a sending peer device, or a peer device that may operate as either a receiving peer device or a sending peer device. The one or more peer devices may be operated by one or more users (e.g., a person). In some cases, a sending peer device may be reconfigured to operate as an additional receiving peer device when a receiving peer device is used to select one or more files for sharing via the ad hoc connection. In some cases, a receiving peer device may be reconfigured to operate as an additional sending peer device when the receiving peer device is used to select one or more files for sharing via the ad hoc connection.

The ad hoc connection may be used to connect a plurality of peer devices to each other in an ad hoc session. The plurality of peer devices may comprise one or more peer devices comprising one or more sending peer devices and/or one or more receiving peer devices. In some cases, the plurality of peer devices may comprise up to eight peer devices comprising one or more sending peer devices and/or one or more receiving peer devices. In other cases, the plurality of peer devices may comprise more than eight peer devices comprising one or more sending peer devices and/or one or more receiving peer devices. An ad hoc session may be a virtual session that allows the plurality of peer devices to communicate with each other through the ad hoc connection using connectivity hardware internal to the plurality of peer devices. The ad hoc session may allow the plurality of peer devices to share media with each other using the ad hoc connection.

The ad hoc session may be initiated using an ad hoc connection and an identifying marker. In some cases, the identifying marker may be an identifying marker of a user or a device of a user (e.g., an MCPeerid). In other cases, the identifying marker may be an identifying marker of the ad hoc session. In such cases, the identifying marker of the ad hoc session may be a quick response (QR) code. Such QR code may correspond to a unique session ID associated with the ad hoc session. The QR code may allow one or more peer devices to join the ad hoc session using an ad hoc connection. The QR code may be generated on any one of the plurality of peer devices. The ad hoc session may allow one or more sending peer devices and/or one or more receiving peer devices to join the ad hoc session and/or connect to each of the plurality of peer devices through an ad hoc connection using the QR code. In some cases, the one or more sending peer devices and/or the one or more receiving peer devices may disconnect from the ad hoc session. The ad hoc session may allow one or more disconnected sending peer devices and/or one or more disconnected receiving peer devices to rejoin the ad hoc session without using the QR code. An ad hoc session may be rejoined if, after one or more sending peer devices and/or one or more receiving peer devices disconnect from the ad hoc session or terminate an ad hoc connection, at least one or more peer devices remain in the ad hoc session. Rejoining an ad hoc session may involve one or more sending peer devices and/or one or more receiving peer devices reconnecting to the at least one or more peer devices remaining in the ad hoc session after the one or more sending peer devices and/or the one or more receiving peer devices disconnect from the ad hoc session or terminate the ad hoc connection. The ad hoc session may allow disconnected peer devices to rejoin the ad hoc session without the QR code within a pre-determined time interval after the disconnected peer devices disconnect from the ad hoc session. In some cases, the pre-determined time interval may be about 10 minutes or less. In other cases, the pre-determined time interval may be at most about 10 minutes, 9 minutes, 8 minutes, 7 minutes, 6 minutes, 5 minutes, 4 minutes, 3 minutes, 2 minutes, 1 minute, or less.

A sending peer device may be a peer device that allows a user to select a media to share with one or more peer devices (e.g., one or more receiving peer devices) connected to the sending peer device through the ad hoc connection. Media may include one or more photos, videos, animated images (e.g., GIF's), documents, and/or any other digital content viewable on a peer device. In some cases, the media may include one or more photos, videos, animated images (e.g., GIF's), documents, and/or any other digital content with one or more notes, drawings, annotations, and/or markings (e.g., text, symbols, ideograms, and/or emojis) that have been added to and/or overlaid on the media by one or more users of the one or more peer devices. The media may be stored locally on the sending peer device. In some cases, the media selected by a user to share with the one or more peer devices may be a media that is captured in real time by a user of the sending peer device using a camera on the sending peer device. In some cases, the sending peer device may select one or more media to share with one or more peer devices. Using a sending peer device to share the media selected for sharing may involve using the ad hoc connection to send a file corresponding to the media selected for sharing from the sending peer device to the one or more receiving peer devices. In some cases, the sending device may send one or more files corresponding to one or more media selected on the sending peer device to share with one or more peer devices. The file corresponding to the media may be stored locally on the sending peer device such that the sending peer device may display and manipulate the media using the file corresponding to the media. Manipulating the media on a sending peer device may involve tapping, double tapping, flicking, dragging, spreading, zooming, pinching, panning, swiping, and/or rotating the media displayed on the peer device. Upon sending of the file from the sending peer device to the one or more receiving peer devices, the media associated with the file may be displayed on the sending peer device and each of the one or more receiving peer devices. In some cases, the sending peer device may manipulate the media displayed on each of the one or more receiving peer devices by manipulating the media displayed on the sending peer device. The sending peer device may manipulate the media displayed on each of the one or more receiving peer devices while the sending peer device is connected to the one or more receiving peer devices through the ad hoc connection. In some cases, the sending peer device may operate as an additional receiving peer device when at least one of the one or more receiving peer devices is used to select an additional media to share with one or more peer devices connected to the at least one of the one or more receiving peer devices through an ad hoc connection. In such cases, the at least one of the one or more receiving peer devices may operate as an additional sending peer device. The additional sending peer device may be used to send an additional file corresponding to an additional media from the additional sending peer device to the additional receiving peer device and the one or more receiving peer devices connected to the additional sending peer device through an ad hoc connection.

The sending peer device may connect to the one or more receiving peer devices using a QR code generated on the one or more receiving peer devices. The sending peer device may use the QR code generated on the one or more receiving peer devices to initiate an ad hoc connection between the sending peer device and each of the one or more receiving peer devices. In some cases, the sending peer device may reconnect to the one or more receiving peer devices after the ad hoc connection between the sending peer device and the one or more receiving peer devices is terminated, without using the QR code generated on the one or more receiving peer devices.

The ad hoc connection may be used to send a file corresponding to a media from the sending peer device to the one or more receiving peer devices. A receiving peer device may be a peer device that may receive the file sent from a sending peer device to the receiving peer device using the ad hoc connection. Upon the receiving of the file sent from the sending peer device to the one or more receiving peer devices at the one or more receiving peer devices, the media associated with the file may be displayed on the sending peer device and each of the one or more receiving peer devices. The file corresponding to the media may be temporarily stored on the one or more receiving peer devices such that the media associated with the file is capable of being displayed and manipulated on the one or more receiving peer device without manipulating the media displayed on the sending peer device. Manipulating the media on the one or more receiving peer devices may involve tapping, double tapping, flicking, dragging, spreading, zooming, pinching, panning, swiping, and/or rotating the media displayed on the one or more receiving peer devices. In some cases, the file corresponding to the media may be temporarily stored in transitory memory on the one or more receiving peer devices. Upon the receiving of the file sent from the sending peer device to the one or more receiving peer devices at the one or more receiving peer devices, the media associated with the file may be displayed on the sending peer device and each of the one or more receiving peer devices.

In some cases, the one or more receiving peer devices may comprise a plurality of receiving peer devices. In such cases, a receiving peer device of the plurality of receiving peer devices may manipulate the media displayed on the receiving peer device without manipulating or modifying the media displayed on one or more other receiving peer devices of the plurality of receiving peer devices. In some cases, the sending peer device may operate as an additional receiving peer device and the receiving peer device may operate as an additional sending peer device. The additional receiving peer device may be a peer device that previously operated as a sending peer device but has changed roles to operate in a manner substantially similar to how the one or more receiving peer devices may operate. The additional sending peer device may be a peer device that previously operated as a receiving peer device but has changed roles to operate in a manner substantially similar to how the sending peer device may operate. In such cases, the additional sending peer device may send an additional file corresponding to an additional media to the additional receiving peer device and the other receiving peer device of the plurality of receiving peer devices. The additional file may correspond to an additional media selected at the additional sending peer device for sharing with the additional receiving peer device and the other receiving peer device. The additional sending peer device may display the additional media on the additional sending peer device. The additional sending peer device may manipulate the additional media displayed on the additional receiving peer device and the other receiving peer device by manipulating the additional media displayed on the additional sending peer device. In some cases, the additional receiving peer device may receive an additional file corresponding to an additional media from the additional sending peer device. The additional file may correspond to an additional media selected at the additional sending peer device for sharing with the additional receiving peer device and the other receiving peer device. The additional receiving peer device may display the additional media on the additional receiving peer device. The other receiving peer device may display the additional media on the other receiving peer device. The additional receiving peer device may manipulate the additional media displayed on the additional receiving peer device without manipulating the additional media displayed on the additional sending peer device and the other receiving peer device. In some cases, at least one of the one or more receiving peer devices may operate as an additional sending peer device when the at least one of the one or more receiving peer devices is used to select an additional media to share with one or more peer devices connected to the at least one of the one or more receiving peer devices through an ad hoc connection. In such cases, the sending peer device may operate as an additional receiving peer device. The additional sending peer device may be used to send an additional file corresponding to an additional media from the additional sending peer device to the additional receiving peer device and the one or more receiving peer devices connected to the additional sending peer device through an ad hoc connection.

The one or more receiving peer devices may connect to the sending peer device using a QR code generated on the sending peer device. In some cases, the one or more receiving peer devices may use the QR code generated on the sending peer devices to initiate an ad hoc connection between the sending peer device and each of the one or more receiving peer devices. The one or more receiving peer devices may also reconnect to the sending peer device after the ad hoc connection between the sending peer device and the one or more receiving peer devices is terminated, without using the QR code generated on the sending peer devices. In other cases, a receiving peer device of the plurality of receiving peer devices may connect to the other receiving peer device of the plurality of receiving peer devices using a QR code generated on the other receiving peer device. In such cases, the receiving peer device may use the QR code generated on the other receiving peer device to initiate an ad hoc connection between the receiving peer device and the other receiving peer device. The receiving peer device may also reconnect to the other receiving peer device after the ad hoc connection between the receiving peer device and the other receiving peer device is terminated, without using the QR code generated on the other receiving peer device.

The methods disclosed herein may further comprise terminating the ad hoc connection. The ad hoc connection between one or more peer devices may be terminated when one or more peer devices disconnect from the ad hoc session established between the one or more peer devices using the ad hoc connection. Upon termination of the ad hoc connection, the file corresponding to the media may not be accessible by the one or more receiving peer devices. In some cases, upon termination of the ad hoc connection, the file corresponding to the media may be removed from the one or more receiving peer devices. In some cases, the file corresponding to the media may be removed from transitory memory of the one or more receiving peer devices. Upon termination of the ad hoc connection, the file corresponding to the media may not be manipulated or modified by the one or more receiving peer devices. In some cases, upon termination of the ad hoc connection, the additional file corresponding to the additional media may not be manipulated or modified by the additional receiving peer device or at least one of the one or more receiving peer devices.

Another different aspect of the present disclosure provides a method for sharing media content in real time. The method may comprise initiating an ad hoc connection between a receiving peer device and a sending peer device. The ad hoc connection may be used to send a file corresponding to a media from the sending peer device to the receiving peer device. Media may include photos, videos, animated images (e.g., GIF's), documents, and/or any other digital content viewable on a peer device. In some cases, the media may include photos, videos, animated images (e.g., GIF's), documents, and/or any other digital content with one or more notes, drawings, annotations, and/or markings (e.g., text, symbols, ideograms, and/or emojis) that have been added to and/or overlaid on the media by one or more users of the one or more peer devices. The media may be stored locally on the sending peer device. The file corresponding to the media may be stored locally on the sending peer device. The media may be selected at the sending peer device for sharing with the receiving peer device connected to the sending peer device through the ad hoc connection. The sending peer device may be used by a user to select a media to share with the receiving peer device connected to the sending peer device through the ad hoc connection. Using the sending peer device to share the media selected at the sending peer device may involve using the ad hoc connection to send a file corresponding to the media from the sending peer device to the receiving peer device. The method may further comprise receiving at the receiving peer device a file corresponding to the media selected at the sending peer device for sharing with the receiving peer device. Upon the receiving of the file at the receiving peer device, the media associated with the file may be displayed on the sending peer device and the receiving peer device. The file corresponding to the media may be stored temporarily on the receiving peer device. In some cases, the file corresponding to the media may be temporarily stored in transitory memory on the receiving peer device. The method may further comprise using the receiving peer device to display and manipulate the media displayed on the receiving peer device without manipulating the media displayed on the sending peer device. In some cases, the sending peer device may manipulate the media displayed on the receiving peer device by manipulating the media displayed on the sending peer device while the sending peer device is connected to the receiving peer device through the ad hoc connection. The method may further comprise terminating the ad hoc connection between the receiving peer device and the sending peer device. Upon termination of the ad hoc connection between the receiving peer device and the sending peer device, the media may not be accessible by the receiving peer device. In some cases, upon termination of the ad hoc connection, the file corresponding to the media may be removed from the receiving peer device. In some cases, the file corresponding to the media may be removed from transitory memory of the receiving peer device. Upon termination of the ad hoc connection, the file corresponding to the media may not be manipulated or modified by the receiving peer device.

In some cases, the sending peer device may send the file corresponding to the media to a plurality of receiving peer devices comprising the receiving peer device. The receiving peer device of the plurality of receiving peer devices may display and manipulate the media displayed on the receiving peer device without manipulating or modifying the media displayed on another receiving peer device of the plurality of receiving peer devices. In some cases, the sending peer device may operate as an additional receiving peer device and the receiving peer device may operate as an additional sending peer device. The additional receiving peer device may be a peer device that previously operated as a sending peer device but has changed roles to operate in a manner substantially similar to how the receiving peer device may operate. The additional sending peer device may be a peer device that previously operated as a receiving peer device but has changed roles to operate in a manner substantially similar to how the sending peer device may operate. In such cases, the additional receiving peer device may receive from the additional sending peer device an additional file corresponding to an additional media selected at the additional sending peer device for sharing with the additional receiving peer device and the other receiving peer device. The additional receiving peer device may display the additional media on the additional receiving peer device. The other receiving peer device may display the additional media on the other receiving peer device. The additional receiving peer device may manipulate the additional media displayed on the additional receiving peer device without manipulating or modifying the additional media displayed on the additional sending peer device and the other receiving peer device. In some cases, the additional sending peer device may send an additional file corresponding to an additional media to the additional receiving peer device and the other receiving peer device. The additional file corresponding to the additional media may be selected at the additional sending peer device for sharing with the additional receiving peer device and the other receiving peer device. The additional sending peer device may display the additional media on the additional sending peer device. The other receiving peer device may display the additional media on the other receiving peer device. The additional sending peer device may manipulate the additional media displayed on the additional receiving peer device and the other receiving peer device by manipulating the additional media displayed on the additional sending peer device. In some cases, upon termination of the ad hoc connection, the additional file corresponding to the additional media may not be manipulated or modified by the additional receiving peer device or at least one of the one or more receiving peer devices.

The sending peer device may connect to the receiving peer device of the plurality of receiving peer devices using a QR code generated on the receiving peer device and/or another receiving peer device of the plurality of receiving peer devices. The sending peer device may use the QR code generated on the receiving peer device and/or the other receiving peer device to initiate an ad hoc connection between the sending peer device and the receiving peer device, or to initiate an ad hoc connection between the sending peer device and the other receiving peer device. In some cases, the sending peer device may reconnect to the receiving peer device and/or the other receiving peer device of the plurality of receiving peer devices after the ad hoc connection between the sending peer device and the receiving peer device is terminated, without using the QR code generated on the receiving peer device or the other receiving peer device of the plurality of receiving peer devices.

The receiving peer device of the plurality of receiving peer devices may connect to the sending peer device using a QR code generated on the sending peer device. In some cases, the receiving peer device may use the QR code generated on another receiving peer device of the plurality of receiving peer devices to initiate an ad hoc connection between the receiving peer device and the sending peer device, or to initiate an ad hoc connection between the receiving peer device and the other receiving peer device. The receiving peer device may also reconnect to the sending peer device and/or the other receiving peer device after the ad hoc connection between the receiving peer device and the sending peer device is terminated, without using the QR code generated on the sending peer device. In other cases, the receiving peer device of the plurality of receiving peer devices may connect to the other receiving peer device of the plurality of receiving peer devices using a QR code generated on the other receiving peer device. In such cases, the receiving peer device may use the QR code generated on the other receiving peer device to initiate an ad hoc connection between the receiving peer device and the other receiving peer device. The receiving peer device may also reconnect to the other receiving peer device after the ad hoc connection between the receiving peer device and the other receiving peer device is terminated, without using the QR code generated on the other receiving peer device.

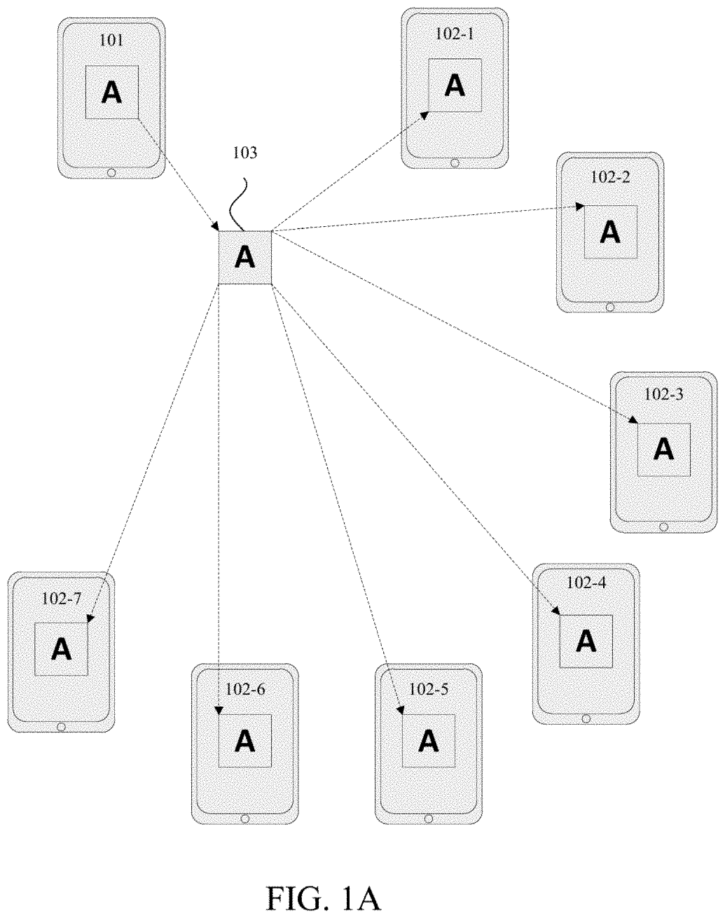

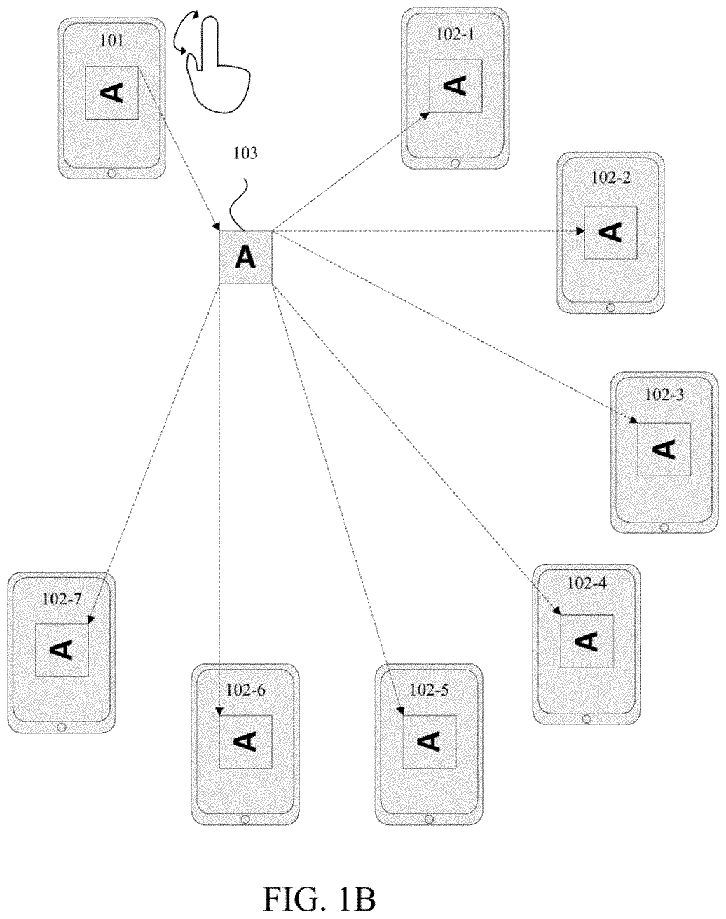

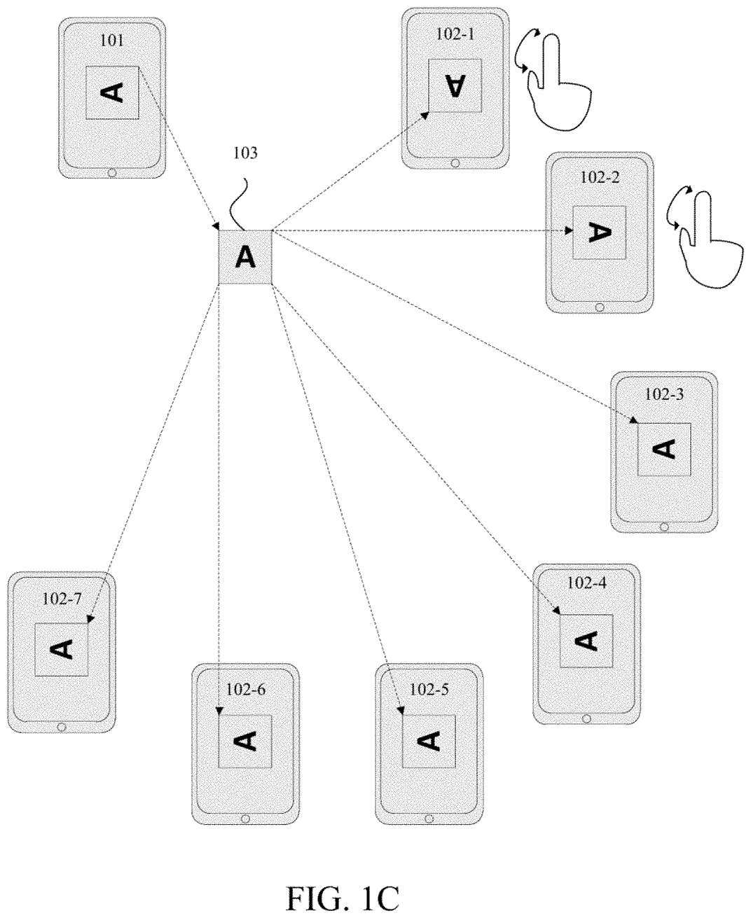

FIG. 1A illustrates an example of an ad hoc media content sharing session initiated between a sending peer device 101 and a plurality of receiving peer devices comprising one or more receiving peer devices 102-1, 102-2, 102-3, 102-4, 102-5, 102-6, and 102-7. A user of the sending peer device 101 may select a media 103 to share with the one or more receiving peer devices 102-1, 102-2, 102-3, 102-4, 102-5, 102-6, and 102-7. The sending peer device 101 may send a file corresponding to a media 103 to the one or more receiving peer devices 102-1, 102-2, 102-3, 102-4, 102-5, 102-6, and 102-7. Upon the sending of the media 103 from the sending peer device 101 to the one or more receiving peer devices, the media 103 may be displayed and manipulated on each of the one or more receiving peer devices 102-1, 102-2, 102-3, 102-4, 102-5, 102-6, and 102-7.

FIG. 1B illustrates a sending peer device 101 that may manipulate the media 103 displayed on each of the one or more receiving peer devices 102-1, 102-2, 102-3, 102-4, 102-5, 102-6, and 102-7. The sending peer device 101 may manipulate the media103 displayed on each of the one or more receiving peer devices by manipulating the media 103 displayed on the sending peer device 101. The sending peer device 101 may manipulate the media 103 using one or more touch gestures (e.g., tap, double tap, flick, drag, spread, pan, zoom, swipe, pinch, and/or rotate) received from a user. The one or more touch gestures received at the sending peer device 101 to manipulate the media 103 may be used to manipulate the media 103 displayed on the one or more receiving peer devices 102-1, 102-2, 102-3, 102-4, 102-5, 102-6, and 102-7 in a synchronized manner. For example, a rotation touch gesture received at the sending peer device 101 may be reproduced on the one or more receiving peer devices such that the media 103 displayed on the one or more receiving peer devices 102-1, 102-2, 102-3, 102-4, 102-5, 102-6, and 102-7 is manipulated in the same manner as the media 103 manipulated on the sending peer device 101 using one or more touch gestures received at the sending peer device 101.

FIG. 1C illustrates a receiving peer device 102-1 that may manipulate the media 103 displayed on the receiving peer device 102-1 without manipulating the media 103 displayed on the sending peer device 101 or the media displayed on the one or more receiving peer devices 102-2, 102-3, 102-4, 102-5, 102-6, and/or 102-7. Another receiving peer device 102-2 of the plurality of receiving peer devices may also manipulate the media 103 displayed on the other receiving peer device 102-2 without manipulating or modifying the media 103 displayed on the sending peer device 101 or the media 103 displayed on the one or more receiving peer devices 102-1, 102-3, 102-4, 102-5, 102-6, and/or 102-7.

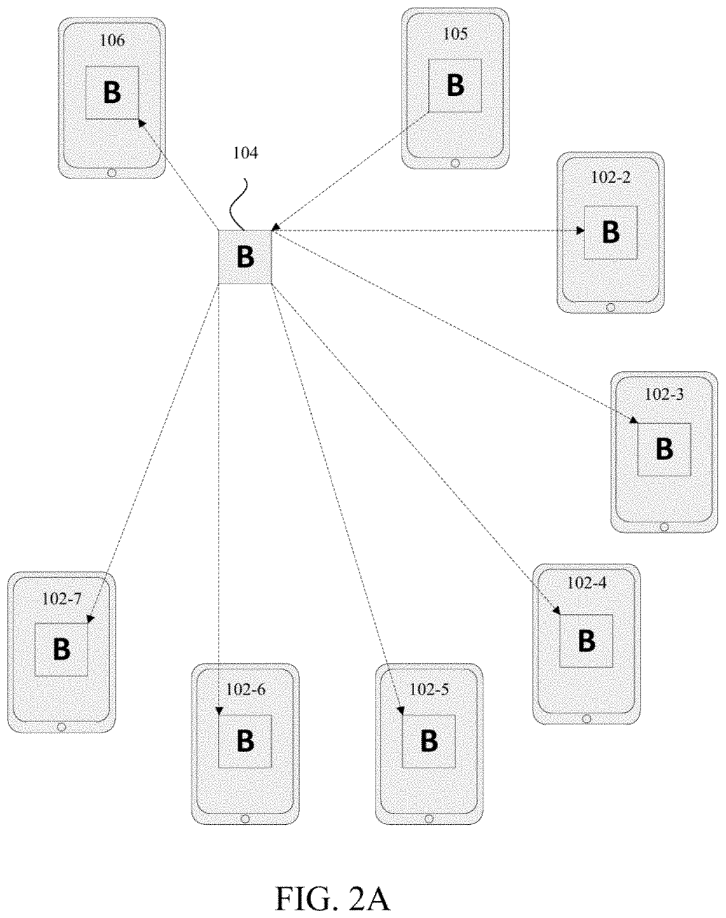

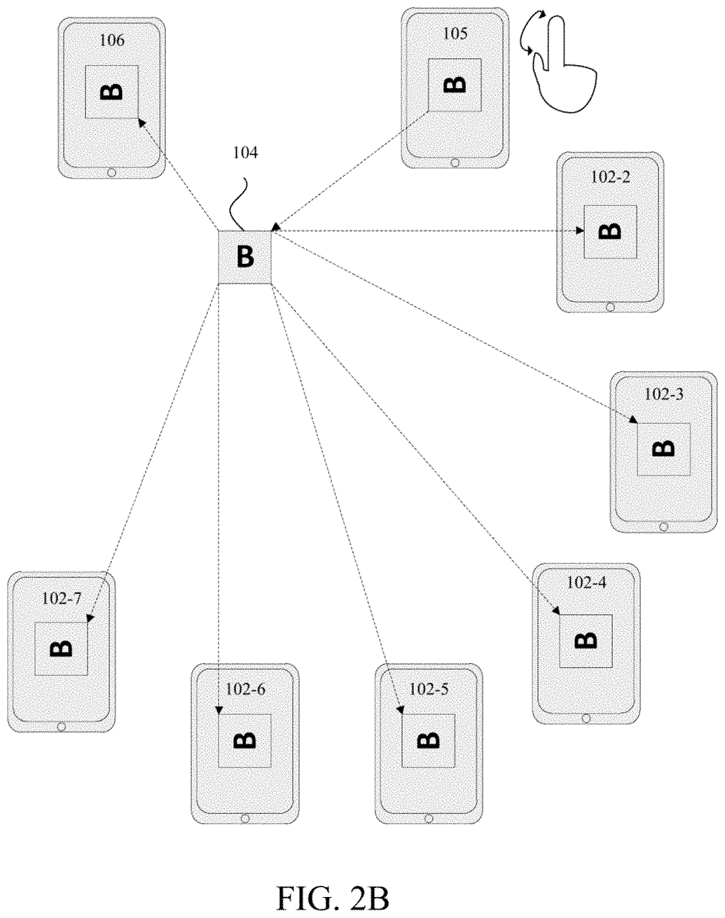

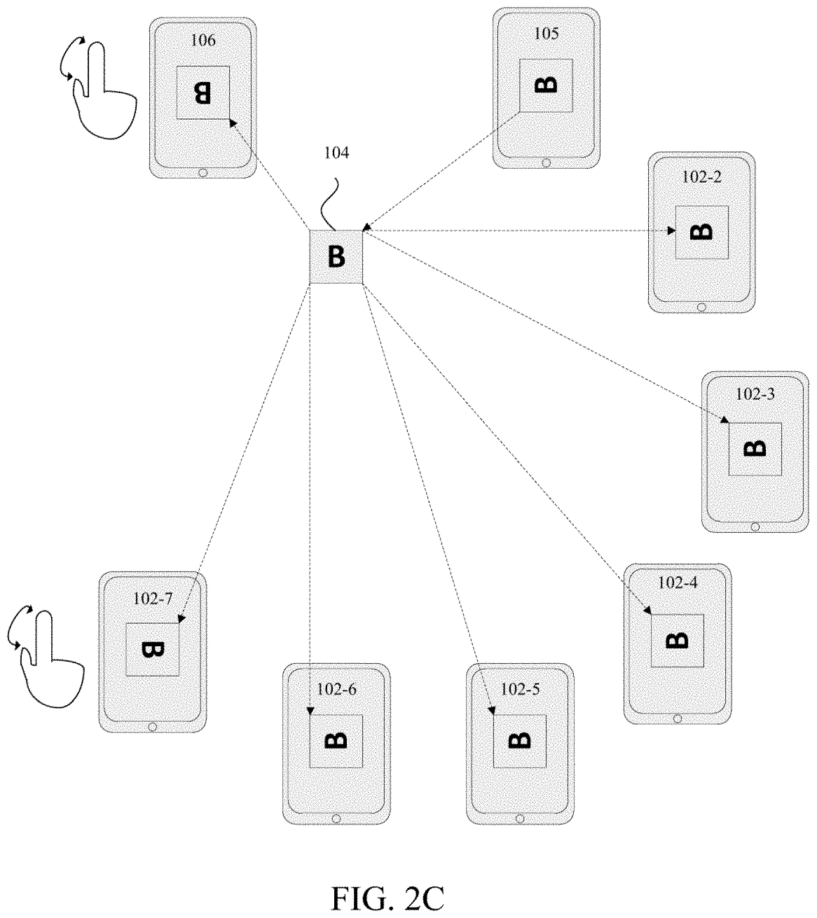

FIG. 2A illustrates an example of a media content sharing session initiated between an additional sending peer device 105, an additional receiving peer device 106, and a plurality of receiving peer devices comprising one or more receiving peer devices 102-2, 102-3, 102-4, 102-5, 102-6, and 102-7. The additional sending peer device 105 may be a peer device (e.g., the receiving peer device 102-1 of FIGS. 1A-1C) that was previously used as a receiving peer device but has changed roles to operate in a manner substantially similar to how a sending peer device (e.g., the sending peer device 101 of FIGS. 1A-1C) may operate. The additional receiving peer device 106 may be a peer device (e.g., the sending peer device 101 of FIGS. 1A-1C) that was previously used as a sending peer device but has changed roles to operate in a manner substantially similar to how a receiving peer device (e.g., the receiving peer device 102-1 of FIGS. 1A-1C) may operate. The additional sending peer device 105 may be used to select an additional media 104 to share with the additional receiving peer device 106 and the one or more receiving peer devices 102-2, 102-3, 102-4, 102-5, 102-6, and 102-7. The additional sending peer device 105 may send an additional file corresponding to the additional media 104 to the additional receiving peer device 106 and the one or more receiving peer devices 102-2, 102-3, 102-4, 102-5, 102-6, and 102-7. Upon the sending of the additional file corresponding to the additional media 104 from the additional sending peer device 105 to the additional receiving peer device 106 and the one or more receiving peer devices 102-2, 102-3, 102-4, 102-5, 102-6, and 102-7, the additional media 104 may be displayed and manipulated on the additional receiving peer device 106 and each of the one or more receiving peer devices 102-2, 102-3, 102-4, 102-5, 102-6, and 102-7.

FIG. 2B illustrates an additional sending peer device 105 that may manipulate the additional media 104 displayed on the additional receiving peer device 106 and each of the one or more receiving peer devices 102-2, 102-3, 102-4, 102-5, 102-6, and 102-7. The additional sending peer device 105 may manipulate the additional media 104 displayed on the additional receiving peer device 106 and each of the one or more receiving peer devices by manipulating the additional media 104 displayed on the additional sending peer device 105. The additional sending peer device 105 may manipulate the additional media 104 using one or more touch gestures (e.g., tap, double tap, flick, drag, spread, pan, zoom, swipe, pinch, and/or rotate) received from a user. The one or more touch gestures received at the additional sending peer device 105 to manipulate the additional media 104 may be used to manipulate the additional media 104 displayed on the additional receiving peer device 106 and the one or more receiving peer devices 102-2, 102-3, 102-4, 102-5, 102-6, and 102-7 in a synchronized manner. For example, a rotation touch gesture received at the additional sending peer device 105 may be reproduced on the additional receiving peer device 106 and the one or more receiving peer devices such that the additional media 104 displayed on the additional receiving peer device 106 and the one or more receiving peer devices 102-2, 102-3, 102-4, 102-5, 102-6, and 102-7 is manipulated in the same manner as the additional media 104 manipulated on the additional sending peer device 105 using one or more touch gestures received at the additional sending peer device 105.

FIG. 2C illustrates an additional receiving peer device 106 that may manipulate the additional media 104 displayed on the additional receiving peer device 106 without manipulating the additional media 104 displayed on the additional sending peer device 105 and the one or more receiving peer devices 102-2, 102-3, 102-4, 102-5, 102-6, and/or 102-7. Another receiving peer device 102-7 of the plurality of receiving peer devices may also manipulate the additional media 104 displayed on the other receiving peer device 102-7 without manipulating or modifying the additional media 104 displayed on the additional receiving peer device 106, the additional sending peer device 105, or the one or more receiving peer devices 102-2, 102-3, 102-4, 102-5, and/or 102-6.

In any of the embodiments described herein, the sending peer device may be configured to have a first level of control. The first level of control may permit the sending peer device to manipulate a first shared media that is displayed on one or more receiving peer devices by manipulating the first shared media that is displayed on the sending peer device. For example, the sending peer device may be used to manipulate a media displayed on the sending peer device, and the manipulation of such media displayed on the sending peer device may also manipulate the media displayed on each of the one or more receiving peer devices. The manipulation of the media displayed on each of the one or more receiving peer devices may be substantially similar or identical to the manipulation of the media displayed on the sending peer device. The manipulation of the media may be performed using any one or more touch gestures as described elsewhere herein.

In any of the embodiments described herein, the one or more receiving peer devices may be configured to have a second level of control that is different than the first level of control. The second level of control may permit each of the one or more receiving peer devices to manipulate a first shared media that is displayed on the one or more receiving peer devices, without manipulating the first shared media that is displayed on any other sending and/or receiving peer device.

The first level of control may permit the sending peer device to manipulate a first shared media by zooming into a first portion of the first shared media, for example. In such cases, each of the one or more receiving peer devices may be configured to display the first shared media as manipulated by or displayed on the sending peer device. In such cases, each of the one or more receiving peer devices may be configured to zoom into the first portion of the first shared media when the sending peer device is used to zoom into the first portion of the first shared media.

The second level of control may permit a first receiving peer device to manipulate the first shared media (e.g., by zooming into a second portion of the first shared media) without manipulating and/or changing the media displayed on the other receiving peer devices or the sending peer device. In such cases, the other receiving peer devices may be used to zoom into a plurality of different portions of the first shared media without manipulating and/or changing the media displayed on the first receiving peer device or the sending peer device. In such cases, the first shared media displayed on the sending peer device may remain unmodified or in a state in which the first shared media was (i) last displayed on the sending peer device or (ii) last modified using the sending peer device (i.e., zoomed into the first portion of the first shared media).

In any of the embodiments described herein, a user may use the sending peer device to share and display a second media (e.g., by swiping to a second media). When the sending peer device registers a swipe gesture to change a first shared media to a second shared media, the sending peer device may be configured to display the second media. The second media may then be displayed on each of the one or more receiving peer devices. The sending peer device may have a first level of control when manipulating the second media. The receiving peer devices may have a second level of control when manipulating the second media. Whenever the sending peer device is used to change the media being shared, presented, and/or displayed, the one or more receiving peer devices may be configured to display the media currently being displayed on the sending peer device or shared using the sending peer device.

As described above, in some cases, a user of at least one receiving peer device may use the at least one receiving peer device to share a plurality of media via the ad hoc connection. In such cases, the at least one receiving peer device may be configured to operate as an additional sending peer device. In such cases, the other receiving peer devices may continue to operate as receiving peer devices. Further, in such cases, the sending peer device that was previously used to share one or more media may be configured to operate as an additional receiving peer device. In such cases, the additional sending peer device may have a first level of control when manipulating the plurality of media shared by the additional sending peer device. In such cases, the other receiving peer devices and the additional receiving peer device may have a second level of control when manipulating the plurality of media shared by the additional sending peer device. In such cases, when the additional sending peer device changes the media being shared, presented, and/or displayed, the other receiving peer devices and the additional receiving peer device may be configured to display the media currently displayed on the additional sending peer device.

### Computer Systems

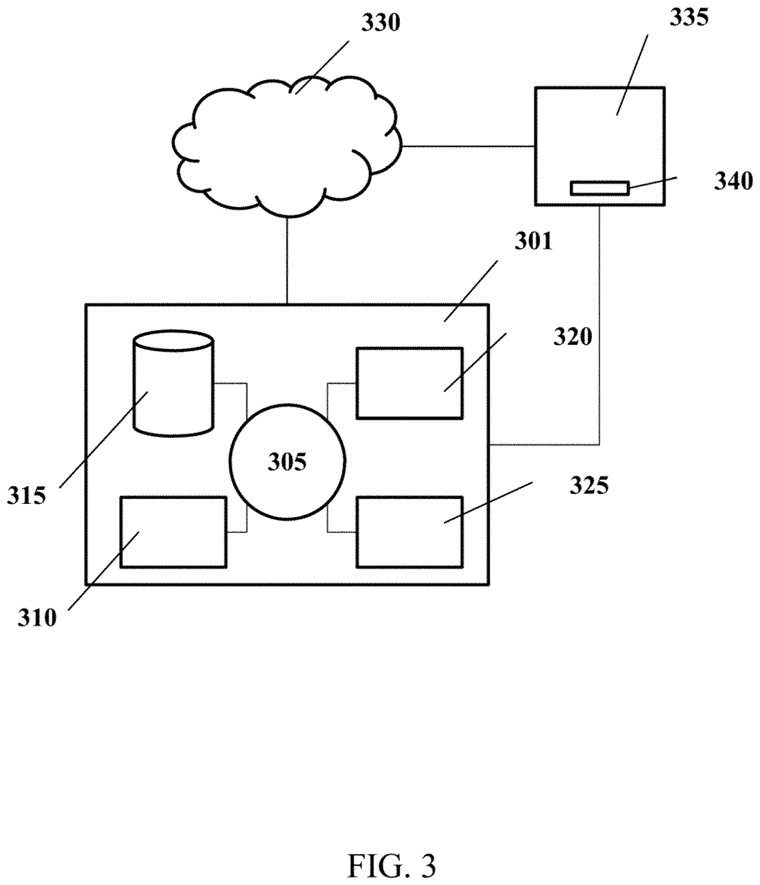

Another aspect of the present disclosure provides computer systems that are programmed or otherwise configured to implement methods of the disclosure. FIG. 3 shows a computer system 301 that is programmed or otherwise configured to implement a method for sharing photos in real time. The computer system 301 may be implemented on a sending peer device and/or a receiving peer device. The computer system 301 may be configured to control the initiation of an ad hoc connection between a sending peer device and a receiving peer device, control the selection of a media stored locally on a sending peer device and/or a receiving peer device for sharing with a plurality of peer devices, control the sending and receiving of a file corresponding to the media selected by a sending peer device and/or receiving peer device to share with a plurality of peer devices, control the manipulation of the media displayed on the sending peer device and/or receiving peer device, and/or control the termination of the ad hoc connection between a sending peer device and a receiving peer device. The computer system 301 can be an electronic device of a user or a computer system that is remotely located with respect to the electronic device. The electronic device can be a mobile electronic device (e.g., the sending peer device and/or the receiving peer device).

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 301, can implement a peer-to-peer network (e.g., an ad hoc connection as described elsewhere herein), which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 301 can be included in the circuit. In some cases, the circuit is an application specific integrated circuit (ASIC).

The storage unit 315 can store files, such as drivers, libraries and saved programs. The storage unit 315 can store user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user (e.g., an end user, a sending peer device operator, a receiving peer device operator, etc.). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display 335 that comprises a user interface (UI) 340 for providing, for example, a portal for displaying and manipulating a media displayed on a sending peer device and/or a receiving peer device. A user can use the portal to control the display of one or more media displayed on a sending peer device or a receiving peer device and/or control the manipulation of the one or more media displayed on the sending peer device or the receiving peer device. The user may use the portal to control the display of one or more media and/or control the manipulation of the one or more media by using one or more much-based gestures (e.g., tap, double tap, flick, drag, spread, pan, zoom, swipe, pinch, and/or rotate). The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm may be configured to control the computer system to initiate an ad hoc connection between a sending peer device and a receiving peer device. The algorithm may also be configured to control a sending peer device and/or receiving peer device to select a media to share with a plurality of peer devices. The algorithm may be further configured to use the ad hoc connection to send a file corresponding to the media from a sending peer device or receiving peer device to the plurality of peer devices connected to the sending peer device or receiving peer device through the ad hoc connection. The algorithm may be further configured to control the display of the media on the sending peer device, receiving peer device, and/or the plurality of peer devices, and the manipulation of the media displayed on the sending peer device, the receiving peer device, and/or the plurality of peer devices. The algorithm may be further configured to control the termination of the ad hoc connection between the sending peer device, the receiving peer device, and/or any one of the plurality of peer devices.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for sharing media in real time, comprising:
(a) initiating an ad hoc connection between a sending peer device and one or more receiving peer devices;
(b) using said sending peer device to select a media to share with said one or more receiving peer devices connected to said sending peer device through said ad hoc connection, wherein a file corresponding to said media is stored locally on said sending peer device such that said media is capable of being displayed and manipulated on said sending peer device;
(c) using said ad hoc connection to send said file from said sending peer device to said one or more receiving peer devices, wherein said media is displayed on said sending peer device and each of said one or more receiving peer devices after said file is sent from said sending peer device and received at said one or more receiving peer devices, and wherein said file is temporarily stored on said one or more receiving peer devices such that said media is capable of being displayed and manipulated on each of said one or more receiving peer devices without manipulating said media displayed on said sending peer device; and
(d) subsequent to (c), terminating said ad hoc connection, wherein upon termination of said ad hoc connection, said file is not accessible by said one or more receiving peer devices.

2. The method of claim 1, further comprising using said sending peer device to manipulate said media displayed on said sending peer device, wherein said manipulation of said media displayed on said sending peer device manipulates said media displayed on each of said one or more receiving peer devices.

3. The method of claim 1, wherein said one or more receiving peer devices comprises a plurality of receiving peer devices, and wherein a first receiving peer device of said plurality of receiving peer devices is configured to manipulate said media displayed on said first receiving peer device without manipulating said media displayed on a second receiving peer device of said plurality of receiving peer devices.

4. The method of claim 3, wherein at least one receiving peer device of said plurality of receiving peer devices is configured to share one or more files via said ad hoc connection, and wherein said sending peer device is configured to operate as an additional receiving peer device and said at least one receiving peer device is configured to operate as an additional sending peer device when said one or more files are shared via said ad hoc connection.

5. The method of claim 4, wherein said additional sending peer device is configured to (i) send an additional file corresponding to an additional media to said additional receiving peer device and another receiving peer device of said plurality of receiving peer devices, (ii) display said additional media on said additional sending peer device, and (iii) manipulate said additional media displayed on said additional sending peer device, wherein said manipulation of said additional media displayed on said additional sending peer device manipulates said additional media displayed on said additional receiving peer device and said another receiving peer device.

6. The method of claim 4, wherein said additional receiving peer device is configured to (i) receive an additional file corresponding to an additional media selected at said additional sending peer device for sharing with said additional receiving peer device and another receiving peer device of said plurality of receiving peer devices, (ii) display said additional media on said additional receiving peer device, and (iii) manipulate said additional media displayed on said additional receiving peer device without manipulating said additional media displayed on said additional sending peer device and said another receiving peer device.

7. The method of claim 1, wherein said sending peer device is configured to connect to said one or more receiving peer devices using a quick response (QR) code generated on said sending peer device.

8. The method of claim 7, wherein said sending peer device is configured to reconnect to at least one receiving peer device of said one or more receiving peer devices after termination of said ad hoc connection between said sending peer device and said at least one receiving peer device, without using said QR code.

9. The method of claim 1, wherein said sending peer device is configured to connect to said one or more receiving peer devices using a quick response (QR) code generated on said one or more receiving peer devices.

10. The method of claim 9, wherein said sending peer device is configured to reconnect to at least one receiving peer device of said one or more receiving peer devices after termination of said ad hoc connection between said sending peer device and said at least one receiving peer device, without using said QR code.

11. A method for sharing media in real time, comprising:
(a) initiating an ad hoc connection between a receiving peer device and a sending peer device;
(b) receiving, at said receiving peer device, a file corresponding to a media selected at said sending peer device for sharing with said receiving peer device connected to said sending peer device through said ad hoc connection, wherein said media is displayed on said sending peer device and said receiving peer device after said file is sent from said sending peer device and received at said receiving peer device, and wherein said file corresponding to said media is stored temporarily on said receiving peer device;
(c) using said receiving peer device to display and manipulate said media displayed on said receiving peer device without manipulating said media displayed on said sending peer device; and
(d) subsequent to (c), terminating said ad hoc connection, wherein upon termination of said ad hoc connection, said media is not accessible by said receiving peer device.

12. The method of claim 11, wherein a manipulation of said media displayed on said sending peer device manipulates said media displayed on said receiving peer device.

13. The method of claim 11, wherein said file corresponding to said media is received at a plurality of receiving peer devices comprising said receiving peer device, and wherein said method further comprises using said receiving peer device to manipulate said media displayed on said receiving peer device without manipulating said media displayed on another receiving peer device of said plurality of receiving peer devices.

14. The method of claim 13, wherein said sending peer device is configured to operate as an additional receiving peer device and said receiving peer device is configured to operate as an additional sending peer device when said receiving peer device is used to share one or more files via said ad hoc connection.

15. The method of claim 14, wherein said additional receiving peer device is configured to (i) receive an additional file corresponding to an additional media selected at said additional sending peer device for sharing with said additional receiving peer device and said another receiving peer device, (ii) display said additional media on said additional receiving peer device, and (iii) manipulate said additional media displayed on said additional receiving peer device without manipulating said additional media displayed on said additional sending peer device and said another receiving peer device.

16. The method of claim 14, wherein said additional sending peer device is configured to (i) send an additional file corresponding to an additional media to said additional receiving peer device and said another receiving peer device, (ii) display said additional media on said additional sending peer device, and (iii) manipulate said additional media displayed on said additional sending peer device, wherein said manipulation of said additional media displayed on said additional sending peer device manipulates said additional media displayed on said additional receiving peer device and said another receiving peer device.

17. The method of claim 11, wherein said receiving peer device is configured to connect to said sending peer device using a quick response (QR) code generated on said sending peer device.

18. The method of claim 17, wherein said receiving peer device is configured to reconnect to said sending peer device after said ad hoc connection is terminated between said receiving peer device and said sending peer device, without using said QR code.

19. The method of claim 11, wherein said receiving peer device is configured to connect to said sending peer device using a quick response (QR) code generated on said receiving peer device.

20. The method of claim 19, wherein said receiving peer device is configured to reconnect to said sending peer device after said ad hoc connection between said receiving peer device and said sending peer device is terminated, without using said QR code.

21. A system for sharing media in real time, said system comprising one or more computer processors and computer memory coupled thereto, wherein said computer memory comprises machine executable code that, upon execution by said one or more computer processors, implements a method for sharing media in real time, said method comprising:
(a) initiating an ad hoc connection between a sending peer device and one or more receiving peer devices;
(b) using said sending peer device to select a media to share with said one or more receiving peer devices connected to said sending peer device through said ad hoc connection, wherein a file corresponding to said media is stored locally on said sending peer device such that said media is capable of being displayed and manipulated on said sending peer device;
(c) using said ad hoc connection to send said file from said sending peer device to said one or more receiving peer devices, wherein said media is displayed on said sending peer device and each of said one or more receiving peer devices after said file is sent from said sending peer device and received at said one or more receiving peer devices, and wherein said file is temporarily stored on said one or more receiving peer devices such that said media is capable of being displayed and manipulated on each of said one or more receiving peer devices without manipulating said media displayed on said sending peer device; and
(d) subsequent to (c), terminating said ad hoc connection, wherein upon termination of said ad hoc connection, said file is not accessible by said one or more receiving peer devices.

22. A system for sharing media in real time, said system comprising one or more computer processors and computer memory coupled thereto, wherein said computer memory comprises machine executable code that, upon execution by said one or more computer processors, implements a method for sharing media in real time, said method comprising:
(a) initiating an ad hoc connection between a receiving peer device and a sending peer device;
(b) receiving, at said receiving peer device, a file corresponding to a media selected at said sending peer device for sharing with said receiving peer device connected to said sending peer device through said ad hoc connection, wherein said media is displayed on said sending peer device and said receiving peer device after said file is sent from said sending peer device and received at said receiving peer device, and wherein said file corresponding to said media is stored temporarily on said receiving peer device;
(c) using said receiving peer device to display and manipulate said media displayed on said receiving peer device without manipulating said media displayed on said sending peer device; and
(d) subsequent to (c), terminating said ad hoc connection, wherein upon termination of said ad hoc connection, said media is not accessible by said receiving peer device.
